(19) United States
(12) Patent Application Publication
(10) Pub. No.: US 2016/0376474 A1
(43) Pub. Date: Dec. 29, 2016

(54) Polyurethane Adhesive Comprising Epoxide Groups

(71) Applicant: Henkel AG & Co. KGaA, Duesseldorf (DE)

(72) Inventors: Holger Eichelmann, Hilden (DE); Marcel Blodau, Krefeld (DE); Andre te Poel, Willich (DE)

(21) Appl. No.: 15/261,012

(22) Filed: Sep. 9, 2016

Related U.S. Application Data
(63) Continuation of application No. PCT/EP2015/055118, filed on Mar. 12, 2015.

(30) Foreign Application Priority Data
Mar. 17, 2014 (DE) 10 2014 204 925.3

(51) Int. Cl. C09J 7/02; C09J 175/08; C09J 175/06; C08G 18/48; C08G 18/30; B32B 37/12; C08G 18/42; C08G 18/66; C08G 18/40; C08G 18/58; B32B 7/12; C09J 5/04; C08G 18/71

(52) U.S. Cl. CPC C09J 7/0296; C09J 5/04; C09J 175/08; C09J 175/06; C09J 7/0285; C09J 7/0282; C09J 7/0275; C09J 7/0292; C08G 18/4829; C08G 18/30; C08G 18/718; C08G 18/42; C08G 18/6666; C08G 18/4045; C08G 18/4018; C08G 18/58; B32B 7/12; B32B 37/12; C09J 2477/008; C09J 2467/008; C09J 2423/108; B32B 2439/70; B32B 2255/26

(57) ABSTRACT

The present invention relates to a polyurethane adhesive, in particular for laminating films, wherein the PU adhesive contains 0.1 to 20 wt % a low molecular weight epoxide comprising at least one epoxide group and at least one hydroxy group, and wherein the epoxide is chemically unbonded or is chemically bonded by means of at least one hydroxy group. The present invention further relates to use of said adhesive for adhesively bonding films, to a method for producing multilayer films, and to multilayer films adhesively bonded with said adhesive.

The present invention relates to a polyurethane adhesive, in particular for laminating films, wherein the PU adhesive contains a low molecular weight epoxide. The present invention further relates to use of said adhesive for adhesively bonding films, to a method for producing multilayer films, and to multilayer films adhesively bonded with said adhesive.

Laminating adhesives are generally known in industry. They are solvent-containing or solvent-free, crosslinking or physically setting adhesives which serve to bond thin, two-dimensional substrates, such as for example plastics films, metal foils, paper, or cardboard, to one another. It is essential here that the adhesive bond only slightly reduces the flexibility of the thin individual plies. Selection of the individual film plies makes it possible to influence specific characteristics of these multilayer films, in particular permeability to water or other liquids, chemical resistance, and permeability to oxygen or other gases.

It is furthermore known that packaging is manufactured from such multilayer films. Foodstuffs in solid, pasty, or liquid form may, for example, be packaged in such packages. Everyday items, for example plastic cutlery, may also be packaged. Such packaging is also suitable for holding medical materials or articles.

The above-stated fields of application mean that as far as possible no low molecular weight substances should migrate out of the packaging into the package contents. Such substances may be flavor-impairing substances or the corresponding substances may have a deleterious effect on health if ingested.

In the case of films bonded with polyurethanes, such substances may in particular comprise breakdown products from the isocyanate precursors used, for example from the hydrolyzed polyisocyanates. Primary amines, in particular primary aromatic amines, may here be formed from such polyisocyanate precursors. These are known to impair health. There are accordingly various standards which specify a maximum content of such primary aromatic amines in films suitable for packaging.

Epoxide-containing adhesives pose a similar problem in that unreacted epoxide monomers migrate into the packaged goods. This is the case in particular under sterilization conditions, especially with steam sterilization.

Such migrated substances are unwanted, particularly in the packaging sector, specifically in foodstuffs packaging. The object of the present invention is therefore to provide epoxide-containing polyurethane adhesives which, after crosslinking, yield an adhesive which, on extended storage or on sterilization, has a reduced content of migrated substances, in particular epoxide monomers.

The object is solved by providing a polyurethane adhesive, in particular for laminating films, wherein the PU adhesive contains at least one NCO-functional polyurethane prepolymer and/or at least one polyisocyanate, wherein the PU adhesive contains 0.1 to 20 wt % a low molecular weight epoxide comprising at least one epoxide group and at least one hydroxy group, and wherein the epoxide is chemically unbonded or is chemically bonded by means of at least one hydroxy group. Even under steam sterilization conditions (“retort conditions”), the adhesives according to the present invention exhibit reduced or no longer detectable migration of epoxide monomers. In addition, the adhesive properties under such steam sterilization conditions are improved. Finally, the disclosed adhesives cure completely at room temperature, without the use of additional catalysts. For these reasons, they are particularly suitable for the production of foodstuffs packaging, especially so-called “retort pouches”.

The invention further relates to a method for producing multilayer films with the use of the PU adhesives described herein, especially those that contain a reduced proportion of migratable epoxide monomers, and to correspondingly produced multilayer films.

In yet another aspect, the invention relates to the use of such polyurethane adhesives as a laminating adhesive.

The molecular weights set forth in the present text refer to the number-average molecular weight (Mn), unless otherwise specified. All molecular weights mentioned are values obtainable by gel permeation chromatography (GPC) according to DIN 55672-1:2007-08, unless otherwise indicated.

“At least one”, as used herein, means one or more, i.e., one, two, three, four, five, six, seven, eight, nine, or more. References made to a component refer to the type of the component, and not to the absolute number of molecules. Thus, “at least one polyol” means, for example, at least one type of polyol, i.e., that one type of polyol or a mixture of a plurality of different polyols can be used. Together with references to weight, references designate all compounds of the relevant type that are contained in the composition/mixture, i.e., that the composition contains no further compounds beyond the given amount of corresponding compounds.

All percentages mentioned in connection with the compositions described herein refer to wt %, each with reference to the relevant mixture, unless explicitly stated otherwise.

“About” or “approximately” as used herein in connection with a numerical value refer to the numerical value ±10%, preferably ±5%.

Polyurethane adhesives are generally known. They are also used for laminating multilayer films. The adhesives suitable according to the invention are one-component polyurethane adhesives or two-component polyurethane adhesives. The one-component polyurethane adhesives comprise one polyisocyanate component, whereas the two-component polyurethane adhesives comprise—in addition to the polyisocyanate component—another component that includes compounds having at least two H-acidic functional groups. H-acidic functional groups are, for example, hydroxy groups, amino groups, mercapto groups, or carboxyl groups. These additional components preferably entail a polyol component, i.e., a component that comprises polyols. The adhesives may be liquid, but may also be hot-melt adhesives. The adhesives may contain solvent, but they are preferably solvent-free. Crosslinking of the polyurethane adhesives suitable according to the invention is based on the reaction of reactive NCO groups with H-acidic functional groups. An alternative crosslinking method involves the reaction of the NCO groups with moisture from the applied adhesive, the substrate, or the surroundings with formation of urea groups. These crosslinking reactions are known and they may also proceed concurrently. The adhesives conventionally contain catalysts, for example amine or tin catalysts, to accelerate such reactions.

As polyisocyanates in the polyisocyanate components, known coating material or adhesive polyisocyanates may be used, these entailing polyisocyanates having two or more isocyanate groups. Suitable polyisocyanates are for example 1,5-naphthylene diisocyanate (NDI), 2,4- or 4,4′-diphenylmethane diisocyanate (MDI), hydrogenated MDI (H12MDI), xylylene diisocyanate (XDI), tetramethylxylylene diisocyanate (TMXDI), di- and tetraalkylene diphenylmethane diisocyanate, 4,4′-dibenzyl diisocyanate, 1,3- or 1,4-phenylene diisocyanate, tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, methylene triphenyl triisocyanate (MIT), phthalic acid bis-isocyanatoethyl ester, trimethylhexamethylene diisocyanate, 1,4-diisocyanatobutane, 1,12-diisocyanatododecane, and dimer fatty acid diisocyanate.

Suitable at least trifunctional isocyanates are polyisocyanates which are obtained by trimerization or oligomerization of diisocyanates or by reaction of diisocyanates with low molecular weight polyfunctional compounds containing hydroxyl or amino groups. Commercially obtainable examples are trimerization products of the isocyanates HDI, MDI or IPDI or adducts of diisocyanates and low molecular weight triols, such as trimethylolpropane or glycerol. Further examples include isocyanurates of hexamethylene diisocyanate (HDI) and isocyanurates of isophorone diisocyanate (IPDI).

Aliphatic, cycloaliphatic, or aromatic isocyanates may in principle be used, but aromatic isocyanates are particularly suitable. The PU adhesives according to the invention may contain the isocyanates in reacted form as PU prepolymers or they contain at least a proportion of low molecular weight—optionally oligomeric—isocyanates. The PU prepolymers may be produced by using the same polyols as are used in the polyol component.

The PU adhesives according to the present invention may also contain isocyanato-functional silanes—such as, for example, those described in EP1456274 A1—as a curing agent for a polyol- or hydroxy-terminated PU prepolymer-containing adhesive mixture.

In the embodiment as a two-component PU adhesive, the adhesive comprises not only the polyisocyanate component but also a second component. This second component comprises compounds having H-acidic functional groups. Preferably, the component entails a polyol component. The polyol component contains at least one polyol. This may entail a single polyol, or—preferably—a mixture of a plurality of polyols. Suitable polyols are aliphatic and/or aromatic alcohols with 2 to 6, preferably 2 to 4, OH groups per molecule. The OH groups may be both primary and secondary.

Suitable aliphatic alcohols include, for example, ethylene glycol, propylene glycol, 1,4-butanediol, 1,5-pentanediol, 1,6-hexanediol, 1,7-heptanediol, 1,8-octanediol and the higher homologues or isomers thereof. More highly functional alcohols are likewise suitable, such as for example glycerol, trimethylolpropane, pentaerythritol and oligomeric ethers of the stated substances.

Reaction products of low molecular weight polyfunctional alcohols with alkylene oxides are preferably used as the polyol component. The alkylene oxides preferably have 2 to 4 C atoms. The reaction products of ethylene glycol, propylene glycol, the isomeric butanediols, hexanediol or 4,4′-dihydroxydiphenylpropane with ethylene oxide, propylene oxide or butylene oxide, or mixtures of two or more thereof are, for example, suitable. The reaction products of polyfunctional alcohols, such as glycerol, trimethylolethane, or trimethylolpropane, pentaerythritol or sugar alcohols, or mixtures of two or more thereof, with the stated alkylene oxides to form polyether polyols are furthermore also suitable. Further polyols usual for the purposes of the invention are obtained by polymerization of tetrahydrofuran (poly-THF). Polyethers which have been modified by vinyl polymers are likewise suitable for use as the polyol component. Such products are for example obtainable by polymerizing styrene or acrylonitrile or a mixture thereof in the presence of polyethers.

Further suitable polyols that are preferable according to the present invention are polyester polyols.

Examples of these are polyester polyols, which are obtained by reacting low molecular weight alcohols, in particular ethylene glycol, diethylene glycol, neopentyl glycol, hexanediol, butanediol, propylene glycol, glycerol, or trimethylolpropane with caprolactone.

Further suitable polyester polyols may be produced by polycondensation. Such polyester polyols preferably comprise the reaction products of polyfunctional, preferably difunctional alcohols and polyfunctional, preferably difunctional and/or trifunctional carboxylic acids or polycarboxylic anhydrides. Compounds suitable for producing such polyester polyols are in particular hexanediol, 1,4-hydroxymethylcyclohexane, 2-methyl-1,3-propanediol, 1,2,4-butanetriol, triethylene glycol, tetraethylene glycol, ethylene glycol, polyethylene glycol, dipropylene glycol, polypropylene glycol, dibutylene glycol and polybutylene glycol. Proportions of trifunctional alcohols may also be added.

The polycarboxylic acids may be aliphatic, cycloaliphatic, aromatic, or heterocyclic, or both. They may optionally be substituted, for example by alkyl groups, alkenyl groups, ether groups or halogens. Suitable polycarboxylic acids are for example succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, glutaric anhydride, maleic acid, maleic anhydride, fumaric acid, dimer fatty acid, or trimer fatty acid, or mixtures of two or more thereof. Proportions of tricarboxylic acids may optionally also be added.

It is, however, also possible to use polyester polyols of oleochemical origin. Such polyester polyols may for example be produced by complete ring opening of epoxidized triglycerides of a fat mixture containing at least in part an olefinically unsaturated fatty acid with one or more alcohols having 1 to 12 C atoms and subsequent partial transesterification of the triglyceride derivatives to yield alkyl ester polyols having 1 to 12 C atoms in the alkyl residue. Further suitable polyols are polycarbonate polyols and dimer diols (from Henkel) and castor oil and the derivatives thereof. Hydroxy-functional polybutadienes, as are for example available under the trade name poly-BD, may be used as polyols for the compositions according to the invention.

Polyacetals are likewise suitable as the polyol component. Polyacetals are taken to mean compounds as are obtainable from glycols, for example diethylene glycol or hexanediol or mixtures thereof, with formaldehyde. Polyacetals which are usable for the purposes of the invention may likewise be obtained by polymerization of cyclic acetals. Polycarbonates are furthermore suitable as polyols. Polycarbonates may, for example, be obtained by the reaction of diols, such as propylene glycol, 1,4-butanediol or 1,6-hexanediol, diethylene glycol, triethylene glycol or tetraethylene glycol or mixtures of two or more thereof with diaryl carbonates, for example diphenyl carbonate, or phosgene. Hydroxy esters of polylactones are likewise suitable.

Another group of polyols may be OH-functional polyurethane polyols, e.g., OH-terminated polyurethane prepolymers.

Polyacrylates bearing OH groups are likewise suitable as a polyol component. These polyacrylates may, for example, be obtained by the polymerization of ethylenically unsaturated monomers which bear an OH group. Ethylenically unsaturated carboxylic acids suitable for this purpose are for example acrylic acid, methacrylic acid, crotonic acid or maleic acid or the esters thereof with C1 to C2 alcohols. Corresponding esters bearing OH groups are for example 2-hydroxyethyl acrylate, 2-hydroxyethyl methacrylate, 2-hydroxypropyl acrylate, 2-hydroxypropyl acrylate, 2-hydroxypropyl methacrylate, 3-hydroxypropyl acrylate, or 3-hydroxypropyl methacrylate, or mixtures of two or more thereof.

PU prepolymers may be produced in a known manner from the above-mentioned polyols and polyisocyanates. A prepolymer containing NCO groups may here be produced from the polyols and isocyanates. Examples thereof are described in EP-A 951493, EP-A 1341832, EP-A 150444, EP-A 1456265, and WO 2005/097861. The corresponding PU prepolymers may be formulated with likewise per se known further auxiliary substances to form laminating adhesives. Such adhesives may optionally also contain organic solvents, provided that these do not react with the isocyanate groups present.

The resulting PU prepolymers comprise isocyanate groups that are reactive with H-acidic functional groups or with water. The molecular weight thereof is preferably 500 to 20,000 g/mol. Preferably, the viscosity of the prepolymers is in the range of 500 to 25,000 mPas at an application temperature of the adhesive in a temperature range of 20° C. to 100° C. (as measured according to Brookfield ISO 2555 at a given temperature).

In addition to the above-mentioned known components, a PU adhesive according to the present invention contains low molecular weight epoxides that contain at least one epoxide group and at least one hydroxy group. Preferably, these compounds contain at least two epoxide groups and/or at least two hydroxy groups (OH groups). Such OH groups—in particular, primary or secondary OH groups—make it possible for the epoxide compounds to react with the NCO groups of the NCO-functional PU prepolymer or of the polyisocyanate, to form a urethane group. The migratability of the epoxide compounds is thereby reduced. In the polyurethane adhesive according to the present invention, the low molecular weight epoxide is present in a form that is either chemically unbonded or is chemically bonded via at least one hydroxy group. This depends essentially on the selected embodiment of the adhesive. Thus, it may be preferred at one time for the low molecular weight epoxide to be present in a chemically unbonded form, but preferred at another time for the low molecular weight epoxide to be present in a form that is chemically bonded via at least one hydroxy group.

In particular, the epoxide is present in a chemically bonded state in the embodiment as a one-component adhesive. For this purpose, the epoxide may be reacted with a polyisocyanate, together with other components—for example, polyols—during the course of the production of the NCO-functional PU prepolymer. The reaction between the at least one hydroxy group of the epoxide compound and an isocyanate group causes the epoxide compound to bond laterally or terminally to the polymer backbone of the PU prepolymer with the formation of a urethane group, or—if the epoxide compound has two or more hydroxy groups—even to be incorporated into the PU polymer as a component of a polymer backbone. Alternatively, the epoxide may also be reacted with the NCO-functional PU prepolymer having been previously produced from polyols and polyisocyanates. Because the hydroxy groups serve to link the epoxide compound to the PU prepolymer or polyisocyanate, it is not necessary for more hydroxy groups to remain after the reaction of the epoxide compound. The at least one hydroxy group of the epoxide compound may thus be completely reacted. However, it is important to ensure that the NCO-functional PU prepolymer still has NCO groups even after the reaction with the epoxide. The NCO groups in the final prepolymer thus should not be completely reacted.

In the embodiment of the adhesive as a two-component adhesive, however, the epoxide is preferably present in a chemically unbonded form, i.e., is free as a mixture component of the respective component that contains the additional H-acidic compounds. During the course of the cross-linking reaction of the polyisocyanate compound and the component that contain the additional H-acidic compounds, the epoxide compound reacts via the hydroxy groups thereof with an NCO group of one of the compounds in the polyisocyanate compound and is thus incorporated into the resulting network.

In the context of the present application, the term “low molecular weight” is preferably understood to mean a molecular weight below 2,000 g/mol. It is thus advantageous if the low molecular weight epoxide compounds have a molecular weight of less than 2,000 g/mol, better yet under 1,500 g/mol, further preferably under 1,000 g/mol, and even more preferably less than 500 g/mol, especially less than 350 g/mol. In turn, the low molecular weight epoxide compound preferably has a molecular weight of more than 74 g/mol, particularly preferably more than 100 g/mol, especially more than 120 g/mol. A molecular weight of 120 to 350 g/mol is especially preferable.

The epoxides may entail, for example, glycidyl ester or ether, in particular, mono or polyglycidyl ethers of a polyol, preferably a monomeric polyol. The epoxides are preferably selected from the group of glycidyl ethers of polyhydric alcohols such as glycerol, erythritol, pentaerythritol, xylitol, sorbitol, or mixtures thereof, with at least one hydroxy group. A sorbitol glycidyl ether having at least one, preferably two or more hydroxy groups is especially preferable as an epoxide.

It is generally preferable for the epoxide compound to have an epoxy equivalent weight (EEW) of 100 to 500 g/mol, preferably from 120 to 350 g/mol. The EEW refers to the mass of the epoxide compound that contains 1 mol of epoxide groups. The EEW can be determined according to DIN EN ISO 3001:199-11.

The low molecular weight epoxide compounds are used in an amount of 0.1 to 20 wt % with respect to the entire adhesive. Preferably, the amount used is 0.5 to 20 wt %, further preferably 1 to 15 wt %, especially preferably 1 to 10 wt %, particularly preferably 1 to 4 wt % with respect to the entire adhesive. The epoxide compound may then be present in a form that is chemically bonded via a hydroxy group, i.e., may have already been chemically reacted so as to preserve the epoxide functionality; otherwise, the epoxide compound is present in a chemically unbonded form, i.e., as a compound that is not reacted any further. For the calculation of the mass percentage in the context of the present application, it is notionally assumed that the low molecular weight epoxide compound is present in a chemically unbonded form, irrespective of whether or not this is actually the case. Should the low molecular weight epoxide compound be bonded to another compound due to a reaction of hydroxy group, then the mass percentage refers to the mass of the low molecular weight epoxide compound before the reaction thereof, and not to the mass of the reaction product.

The adhesive according to the present invention may also contain conventionally used additives. The additional components entail, for example, resins (tackifiers), catalysts, e.g., based on organometallic compounds or tertiary amines, such as tin compounds or 1,4-diazabicyclo[2.2.2]octane (DABCO), stabilizers, cross-linking agents, viscosity regulators, fillers, pigments, plasticizers, or antioxidants.

One-component PU adhesives generally contain one or more NCO-functional PU prepolymers. These usually crosslink to adhesives under the action of water—as a component of the substrate to be adhered or from the air. Two-component PU adhesives contain one component that contains the above-mentioned PU prepolymers or the above-mentioned polyisocyanates. As a second crosslinking component, it is possible to use H-acidic compounds, e.g., compounds having hydroxy groups, amino groups, mercapto groups, or carboxyl groups. For example, the above-mentioned polyols may be used, including polyurethane polyols, polyamides, or SH group-containing polymers. The two components are mixed together to form a reactive adhesive immediately prior to the application. This must be treated prior to the progression of the cross-linking reaction.

The following is used in various embodiments as a PU adhesive: a mixture of polyols (in particular, polyester polyols comprising polyhydric monomeric alcohols and/or polyhydric polyether polyols), at least one hydroxy-functionalized epoxide (in particular, a mono or polyglycidyl ether of a monomeric polyol, e.g., sorbitol), and at least one polyisocyanate (in particular, an isocyanato-functionalized silane, e.g., an HDI isocyanurate silane).

Preferably, the polyurethane adhesives according to the present invention are liquid at application temperatures, either at room temperature or as a hot-melt adhesive, so that said polyurethane adhesives can be applied in liquid form during the method for producing multilayer films. It is particularly preferable for the PU adhesives according to the present invention to be liquid at room temperature.

The adhesives described herein may contain solvents or may be solvent-free. Basically, all solvents known to the person skilled in the art can be used as the solvent, particularly esters, ketones, halogenated hydrocarbons, alkanes, alkenes and aromatic hydrocarbons. Exemplary solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, di-isobutyl ketone, dioxane, ethyl acetate, ethylene glycol monobutyl ether acetate, ethylene glycol monoethyl acetate, 2-ethylhexyl acetate, glycol diacetate, heptane, hexane, isobutyl acetate, isooctane, isopropyl acetate, methyl ethyl ketone, tetrahydrofuran, or tetrachloroethylene, or mixtures of two or more of the cited solvents.

They may be applied to the adherend substrates—in particular, films—with the conventional equipment and all of the commonly used application methods, for example, by spraying, doctoring, a ¾-roller coating mechanism in the case of the use of a solvent-free system, or a 2-roller coating mechanism in the case of the use of a solvent-containing system. After application, the adherend substrates, in particular, films, are laminated and adhered to one another in a known manner. It is then appropriate to use elevated temperatures if necessary in order to achieve a better application and more rapid cross-linking reaction. However, the adhesives according to the present invention already exhibit a very favorable curing at room temperature or only slightly elevated temperatures, such as 40° C.

The polyurethane adhesives according to the invention are in particular suitable as laminating adhesives. They may be used in a process in which known films based on polymers, such as PP, PE, OPA, polyamide, PET, polyester, or metal foils are bonded to one another. The adhesive according to the invention is here applied onto an optionally pretreated or printed film. This may proceed at elevated temperature in order to obtain a thin and uniform coating. A second film of identical or a different material is then laminated thereon under pressure. Heat may be applied, to crosslink the adhesive and obtain a multilayer film. The multilayer film may optionally also be composed of more than two layers.

The films are conventionally placed in storage after production. During this time, the adhesives according to the invention may crosslink further. The primary amino groups which arise, in particular primary aromatic amino groups, may react over this time with the epoxide groups which are additionally present. This gives rise to reaction products which comprise no active amine functions and which can no longer migrate.

It is furthermore possible on subsequent processing of the films for a step for heating the bonded multilayer films to be provided. This may, for example, also proceed in a moist atmosphere, for example on sterilization. At these elevated temperatures too, it is possible according to the invention for the primary aromatic amines which arise to react with the epoxide groups of the low molecular weight epoxides which are still present in the crosslinked laminating adhesive layer.

Thanks to the use of the liquid or hot-melt adhesives according to the invention as the laminating adhesive, it is possible to obtain laminated two-layer or multilayer films which meet the stringent requirements for suitability for foodstuffs or medical packaging. In particular, it is possible to achieve a distinct reduction in the content of epoxide monomers and, where applicable, also primary aromatic amines, which are extracted from the film in the relevant test methods.

In particular, it is possible to obtain film that have an epoxide monomer content of less than 1 ppb (parts by weight) of extraction solution, as measured with LC-ESI-MS. A sample of the epoxide assumed to have a content of 100% was used as a standard. It is also possible to obtain films having a primary aromatic amine content of less than 10 μg/1 L of extraction solution. The effect is here observable immediately after crosslinking of the adhesive, but it is however also encountered after subsequent sterilization.

Thanks to the polyurethane adhesives according to the present invention, it is possible to produce adhesives which are outstandingly suitable as a laminating adhesive. Application properties, crosslinking, and adhesion of the films to one another are very good. However, bonding with the adhesives according to the present invention gives rise to only very small quantities of migratable epoxide monomers/primary aromatic amines in the adhesive layer, and said epoxide monomers and amines are strongly bound in the film. This property is also retained in a multilayer film according to the present invention if it is also subjected to sterilization or other heating to an elevated temperature over the course of its production process. In particular, even steam sterilization conditions in the temperature range of 121° C. to 134° C. for periods of up to 60 minutes give rise to only very small amounts of migratable epoxide monomers, or even none at all.

The present invention shall be described in further detail below with several examples. Quantities specified therein refer to wt %, unless otherwise specified.

It shall be readily understood that all embodiments disclosed herein in connection with the PU adhesive can also be used for the uses and methods described, and vice versa.

### EXAMPLES

### Example 1 (According to the Invention)

1 wt % Pluracol PEP 450 (polyether tetrol) and 2.5 wt % Erisys GE 60 (sorbitol glycidyl ether, EEW 160-195) were added to Liofol PES 228 (60 wt % solids content, OH-terminated and predissolved polyester). The resulting mixture was mixed at a ratio of 11:2 (parts by mass) with Liofol UR 7391 (HDI isocyanurate silane curing agent) and diluted to a solids content of 35 wt %, in order to obtain an adhesive composition. Laminates of a polyethylene terephthalate (PET)/aluminum prelaminate and oriented polyamide (OPA) and cast polypropylene (CPP) were produced; in each, 4.5 g/m² (dry) of the adhesive composition was applied onto the adherend films and laminated with a laminating machine (Nordmeccanica Labo Combi). The laminate was cured for 14 days at room temperature. For the sterilization test, a 14.4 cm×14.4 cm pouch was produced from the laminate, filled with 2-8 g Tenax TA (porous polymer resin based on 2,6-diphenylene oxide, cleaned by washing with CH₂Cl₂), sealed, and sterilized. The sterilization conditions were a maximum of 134° C. for 60 minutes. Thereafter, the Tenax was tested for the presence of epoxide monomers (Erisys GE 60) by means of liquid chromatography and ESI-MS. No monomers were detected. Limit of detection: 1 ppb (parts by mass)

### Example 2 (Not According to the Invention)

1 wt % Pluracol PEP 450 (polyether tetrol) and 2.5 wt % EPON 828 (bisphenol A diglycidyl ether, “BADGE”, EEW-184-190) were added to Liofol PES 228 (60 wt % solids content, OH-terminated and predissolved polyester). The resulting mixture was mixed at a ratio of 23:2 (parts by mass) with Liofol UR 7391 (HDI isocyanurate silane curing agent) and diluted to a solids content of 35 wt %, in order to obtain an adhesive composition. Laminates of a polyethylene terephthalate (PET)/aluminum prelaminate and oriented polyamide (OPA) and cast polypropylene (CPP) were produced; in each, 4.5 g/m² (dry) of the adhesive composition was applied onto the adherend films and laminated with a laminating machine (Nordmeccanica Labo Combi). The laminate was cured for 14 days at room temperature. For the sterilization test, a 14.4 cm×14.4 cm pouch was produced from the laminate, filled with 2-8 g Tenax TA (porous polymer resin based on 2,6-diphenylene oxide, cleaned by washing with CH₂Cl₂), sealed, and sterilized. The sterilization conditions were a maximum of 134° C. for 60 minutes. Thereafter, the Tenax was tested for the presence of epoxide monomers (EPON 828) by means of liquid chromatography and ESI-MS. Monomers were detected.

1. A polyurethane adhesive for laminating films, wherein the PU adhesive is prepared from at least one NCO-functional polyurethane prepolymer and/or at least one polyisocyanate, and 0.1 to 20 wt % relative to the adhesive of at least one low molecular weight epoxide bearing at least one epoxide group and at least one hydroxy group, wherein the epoxide can be chemically unbonded or can be chemically bonded to an isocyanate group by means of at least one hydroxy group.

2. The polyurethane adhesive according to claim 1, wherein the at least one low molecular weight epoxide bearing at least one epoxide group and at least one hydroxy group is a glycidyl ester or ether of a polyol.

3. The polyurethane adhesive according to claim 1, wherein the at least one low molecular weight epoxide bearing at least one epoxide group and at least one hydroxy group is a mono or polyglycidyl ether of a polyol.

4. The polyurethane adhesive according to claim 1, wherein the at least one low molecular weight epoxide bearing at least one epoxide group and at least one hydroxy group is selected from the group consisting of glycidyl ethers of glycerol, erythritol, pentaerythritol, xylitol, sorbitol, or mixtures thereof.

5. The polyurethane adhesive according to claim 1, wherein the at least one low molecular weight epoxide bearing at least one epoxide group and at least one hydroxy group is sorbitol glycidyl ether.

6. The polyurethane adhesive according to claim 1, wherein the at least one low molecular weight epoxide bearing at least one epoxide group and at least one hydroxy group is an epoxide having an EEW of 100 to 500 g/mol.

7. The polyurethane adhesive according to claim 1, wherein the at least one low molecular weight epoxide bearing at least one epoxide group and at least one hydroxy group is an epoxide having an EEW of 120 to 350 g/mol.

8. The polyurethane adhesive according to claim 1, wherein the PU adhesive contains at least one polyol.

9. The polyurethane adhesive according to claim 1, wherein the PU adhesive contains at least one polyester polyol.

10. The polyurethane adhesive according to claim 1, wherein the PU adhesive contains at least one polyisocyanate, selected from the group consisting of:
(i) isocyanurates of hexamethylene diisocyanate (HDI), isocyanurates of isophorone diisocyanate (IPDI), adducts of aliphatic or cycloaliphatic diisocyanates and low molecular weight triols;
(ii) isocyanato-functional silanes; and
(iii) mixtures of any of the compounds according to (i) and (ii).

11. The polyurethane adhesive according to claim 10, wherein the isocyanato-functional silanes are the reaction product of a low-volatility aliphatic or cycloaliphatic polyisocyanate with an organofunctional silane having NCO-reactive groups.

12. Cured reaction products of the polyurethane adhesive according to claim 1.

13. A plurality of films bonded together by cured reaction products of the polyurethane adhesive according to claim 1.

14. A packaging laminate comprising a plurality of films bonded together by cured reaction products of the polyurethane adhesive according to claim 1.

15. A sealed package enclosing foodstuffs comprising a plurality of films bonded together by cured reaction products of the polyurethane adhesive according to claim 1.

16. A method for producing laminated multilayer films, comprising:
providing first and second films;
providing the polyurethane adhesive according to claim 1;
disposing the polyurethane adhesive onto a surface of the first and/or second film; and
laminating the first and second films with the disposed adhesive therebetween.

17. The method according to claim 16, wherein the films are adhered at an elevated temperature between 30° C. and 60° C.

18. The method according to claim 16, wherein after curing, the adhered films are subjected to a further step of sterilization.
